(19) United States
(12) Patent Application Publication
(10) Pub. No.: US 2010/0078578 A1
(43) Pub. Date: Apr. 1, 2010

(54) METHOD AND ARRANGEMENT FOR THE OPERATION OF PLASMA-BASED SHORT-WAVELENGTH RADIATION SOURCES

(75) Inventors: Max Christian Schuermann, Luebbecke (DE); Boris Tkachenko, Hannover (DE); Denis Bolshukhin, Goettingen (DE); Juergen Kleinschmidt, Goettingen (DE); Guido Schriever, Goettingen (DE)

Correspondence Address: HOUSTON ELISEEVA, 4 MILITIA DRIVE, SUITE 4, LEXINGTON, MA, 02421, US

(73) Assignee: XTREME TECHNOLOGIES GMBH, Goettingen (DE)

(21) Appl. No.: 12/563,305

(22) Filed: Sep. 21, 2009

(30) Foreign Application Priority Data
Sep. 27, 2008 (DE) 10 2008 049 494.1

(51) Int. Cl. G21K 5/00

(52) U.S. Cl. 250/504 R

(57) ABSTRACT

The invention is directed to a method for operating plasma-based short-wavelength radiation sources, particularly EUV radiation sources, having a long lifetime and to an arrangement for generating plasma-based short-wavelength radiation. It is the object of the invention to find a novel possibility for operating plasma-based short-wavelength radiation sources with a long lifetime which permits extensive debris mitigation without the main process of radiation generation being severely impaired through the use of buffer gas and without the need for substantial additional expenditure for generating partial pressure in a spatially narrowly limited manner. According to the invention, this object is met in that hydrogen gas as buffer gas (41) is introduced into the vacuum chamber (1) under a pressure such that a pressure-distance product in the range of 1 to 100 Pa·m is realized while taking into account the geometric radiation paths of the radiation emitted by the emitter plasma (21) within the buffer gas (41; 44), and the vacuum chamber (1) is continuously evacuated for adjusting a quasistatic pressure (42; 47) and for removing residual emitter material and buffer gas (41).

### RELATED APPLICATIONS

This application claims priority to German Patent Application No. 10 2008 049 494.1, filed Sep. 27, 2008, which is incorporated herein by reference in its entirety.

### FIELD OF THE INVENTION

The invention is directed to a method and an arrangement for the operation of plasma-based short-wavelength radiation sources, particularly EUV radiation sources, having a long lifetime. The invention is preferably applied in radiation sources for semiconductor lithography.

### BACKGROUND OF THE INVENTION

As per the state of the art, there are currently two basic concepts that are considered promising for EUV lithography: Laser-Produced Plasma (LPP) radiation sources and Gas Discharge Plasma (GDP) radiation sources.

In both concepts, an emitter element (typically Xe, Sn or Li, or chemical compounds formed therefrom) is excited by laser radiation or electrical current to form a hot plasma which then emits radiation with a high proportion in the desired wavelength range around 13.5 nm. As a secondary effect, charged or uncharged particles (debris) escape from the plasma with high thermal energy and at high velocity. As a result of their impact upon surfaces of adjacent components (electrodes, optics, sensors, etc.), these high-energy particles cause a removal of material (sputtering) leading to considerable damage to these components in the course of continuous operation of the radiation source. The principal object of debris mitigation in EUV radiation sources is to prevent such damage.

Reduction of sputtering due to high-energy particles is always achieved in the same way by slowing down the fast particles through collisions (impacts) in a flowing buffer gas (e.g., a gas curtain as is disclosed in DE 102 15 469 B4 and DE 10 2005 015 274 A1) and/or capturing these fast particles by adhesion in a lamella filter (as is described, e.g., in DE 102 37 901 B3).

However, it is important that the EUV radiation is able to pass through this buffer gas without very high transmission losses. Consequently, the buffer gas should have a small absorption cross section for the generated radiation, the absorption distance should be short, and the gas pressure should be low.

A certain minimum quantity of impact events is necessary for decelerating a particle. The quantity of impacts undergone on average by a particle along a given distance is proportional to the pressure. As a result, the braking effect on the particle is proportional to the product of pressure and distance. Accordingly, in order that components located in the vicinity of the plasma are also protected effectively it is advantageous when the pressure around the plasma is high and the radiation path in the area of high pressure is short. In this regard, two limitations are encountered.

On the one hand, the high pressure can adversely affect the plasma (or its development, primarily in gas discharge sources). On the other hand, there are no transparent materials (windows) for EUV radiation. Therefore, beam guidance must be carried out in evacuated systems. However, at the same time, a large solid angle area of the radiation emitted by the plasma must be bundled through collector optics. This results in large apertures even at a short distance from the plasma, between which it is very difficult to realize high pressure gradients for spatially limiting a region of high gas pressure.

The latter can only be accomplished dynamically in any case by letting a buffer gas flow into a vacuum chamber, which is necessary for generating plasma, in such a way that a defined higher partial pressure builds up in certain areas where the buffer gas flows in and a quasistatic equilibrium pressure between the increased partial pressure and the vacuum system pressure occurs in other areas through a determined leakage rate of the buffer gas area. This concept is realized in the form of gas curtains, mentioned above, and in lamella filter structures (foil traps).

The lamella filters are foil structures which have a high flow resistance in spite of a high geometric transmission and a large aperture so that an appreciably higher partial pressure of the buffer gas is maintained inside the lamella structure compared with the rest of the evacuated radiation source volume.

In a first approximation, the minimum quantity of impacts required for sufficient deceleration of a fast particle at a given velocity is minimal when the fast particle and its colliding counterpart have the same mass. However, the quantity of impacts undergone by a particle on a given path length in a gas at a given pressure depends on the impact cross section of the selected buffer gas. This impact cross section increases as the atomic radius increases so that, in general, heavy gases are more efficient at a given pressure and given path length.

In view of the fact that, aside from lithium, the efficient EUV emitters, namely, xenon and tin, are heavy elements, the buffer gas should be as heavy as possible from a mechanical standpoint with respect to impact so that, for example, a gas pressure that is as low as possible can be selected for a given path length.

The emitter elements themselves are not suitable as buffer gases because they are either not gases (Sn, Li) and/or their absorption cross section for EUV radiation is too high (Xe, Sn, Li). Further, it must be ensured when selecting a suitable buffer gas that this buffer gas does not damage the materials used in the system either directly or photochemically. Therefore, in practice, Ar, Kr or N₂ are used as buffer gases almost exclusively.

Because of its spatial proximity to the emitter plasma, a buffer gas is strongly excited and, as a result, reaches very high temperatures. In gas discharge-based plasma radiation sources, it is not even possible to prevent the buffer gas from being directly excited by the electrical current of the discharge. In such cases, unwanted effects are brought about by an unavoidable injection of energy into the buffer gas.

One such effect is that the buffer gas, similar to the actual emitter material, emits characteristic radiation whose wavelength is not only not useful for EUV lithography but can also lead to faulty exposure. This can be countered through the use of suitable spectral filters (so-called out-of-band radiation filters), but this would lead to additional absorption losses or reflection losses of EUV radiation. Further, the energy that is diverted for this unproductive wavelength excitation cannot be used to generate the desired EUV emission, and the unusable wavelength radiation leads to additional thermal loading of the optical components.

Another unwanted effect consists in that the buffer gas (e.g., Ar, Kr or N₂) can be so strongly excited that it becomes a source of high-energy particles itself. These high-energy particles, like the high-energy particles of the emitter element, sputter the surfaces of adjacent components (so-called secondary sputtering).

Since the buffer gas impairs some properties of an EUV radiation source for the reasons stated above, the manner and extent of its use is always a compromise between these undesirable secondary effects and the desired principal effect of prolonging the lifetime of cost-intensive components through debris mitigation.

### SUMMARY OF THE INVENTION

It is the object of the invention to find a novel possibility for operating plasma-based short-wavelength radiation sources with a long lifetime which permits extensive debris mitigation without the main process of radiation generation being severely impaired through the use of buffer gas and without the need for substantial additional expenditure for strict spatial limiting of partial pressure generation.

According to the invention, this object is met in a method for operating plasma-based short-wavelength radiation sources, particularly EUV radiation sources, having the following steps:

an emitter material with a high emission efficiency in the desired wavelength range is supplied in a metered manner for generating an emitter plasma inside a vacuum chamber;

hydrogen gas as buffer gas is introduced into the vacuum chamber under pressure such that a pressure-distance product in the range of 1 to 100 Pa·m is adjusted within the buffer gas while taking into account the geometric radiation paths of the radiation emitted by the emitter plasma;

a spatially narrowly limited hot emitter plasma is generated by a directed energy feed;

fast particles of emitter material are slowed down through impacts with the hydrogen buffer gas particles;

the short-wavelength radiation exiting divergently from the emitter plasma is bundled by means of the collector optics;

the vacuum chamber is continuously suctioned off for quasistatic pressure adjustment in the vacuum chamber and for removing residual emitter material and excess buffer gas.

The emitter material is advantageously provided as a target jet in the vacuum chamber and is excited by an energy beam at a predetermined interaction point to generate the emitter plasma. In this connection, the target jet can be supplied as a continuous liquid jet or as a discontinuous liquid jet (droplet jet) and can preferably be excited by means of a laser beam.

Alternatively, it has proven advisable that the emitter material is supplied as a gas flow between two electrodes provided in the vacuum chamber and is excited by an electric discharge between the electrodes in order to generate the emitter plasma.

Regardless of the selected type of plasma generation, the hydrogen gas as buffer gas is advantageously kept under a pressure quasistatically in the entire vacuum chamber such that a pressure-distance product in the range of 1 to 100 Pa·m is realized depending on a geometric radiation path from the emitter plasma to the collector optics, so that fast debris particles are slowed down along said geometric radiation path through the vacuum chamber to a thermal energy below their ability to sputter.

It has proven advantageous when the hydrogen, as buffer gas, is kept under a pressure quasistatically in the entire vacuum chamber such that a pressure-distance product in the range of 1 to 100 Pa·m is realized while taking into account the geometric radiation paths of the radiation emitted by the plasma and, in addition, another buffer gas is streamed in by supersonic nozzles in the form of a gas curtain arranged lateral to the radiation direction. In so doing, hydrogen can likewise advantageously be streamed in as buffer gas by supersonic nozzles for the gas curtain arranged lateral to the radiation direction.

As an alternative variant, buffer gas can be streamed in within a lamella structure in addition to the hydrogen gas which, as buffer gas, is kept under a pressure quasistatically in the entire vacuum chamber for realizing a pressure-distance product in the range of 1 to 100 Pa·m. In this case also, hydrogen can preferably be streamed into the lamella structure as buffer gas at increased pressure.

Further, in an arrangement for generating plasma-based short-wavelength radiation in which means for supplying an emitter material having a high emission efficiency in the extreme ultraviolet spectral range, means for exciting the emitter material to form a spatially narrowly limited hot emitter plasma, and means for suppressing debris particles generated from the emitter plasma are provided in a vacuum chamber, the above-stated object is met according to the invention in that a feed device for introducing hydrogen gas as buffer gas into the vacuum chamber is provided as means for debris mitigation, and in that means for regulating pressure are connected to the vacuum chamber, and the hydrogen gas is adjusted quasistatically by the means for regulating pressure to a pressure such that a pressure-distance product in the range of 1 to 100 Pa·m is realized while taking into account the geometric radiation paths of the radiation emitted by the emitter plasma up to the collector.

The feed device for the hydrogen gas is advantageously arranged at any location in the vacuum chamber and is adjusted in such a way that the hydrogen, as buffer gas, has a quasistatic pressure in the entire vacuum chamber at which a pressure-distance product in the range of 1 to 100 Pa·m is realized depending on the geometric radiation path within a collision volume from the emitter plasma up to the collector optics so that fast debris particles are slowed down along the path through the collision volume to a thermal energy below the sputtering limit.

The feed device for the hydrogen gas is preferably arranged in such a way that the hydrogen is supplied in the immediate vicinity of the emitter plasma at increased partial pressure relative to the pressure in the rest of the vacuum chamber, and a vacuum system of the vacuum chamber is provided at the same time for sucking out the buffer gas and adjusting a quasistatic hydrogen pressure in the rest of the vacuum chamber.

In another construction, the feed device for the hydrogen gas can be arranged in such a way that the hydrogen is supplied in the immediate vicinity of the emitter plasma at increased partial pressure relative to the pressure of the vacuum chamber in the area of the emitter plasma, and at least one separate gas sink is provided in the vicinity of the plasma for locally limiting a volume with increased partial pressure. In this connection, either a suitable lamella filter or a gas curtain lateral to the mean propagation direction of the emitted radiation can advisably be arranged in the immediate vicinity of the emitter plasma as means for introducing buffer gas at increased partial pressure.

The underlying idea of the invention is based on the consideration that a buffer gas for suppressing fast ions emitted from the plasma must ensure a high braking effect and, in spite of this, a high transmission for EUV radiation. Gases with a large atomic mass or molecular mass (e.g., xenon, krypton or nitrogen) have a good braking effect for particles from the plasma but poor transmission and need to be applied under low partial pressure or in very thin volumes (gas curtains). Further, the emission of characteristic radiation of the buffer gas elements caused by the strong excitation is troublesome because this increases the proportion of out-of-band radiation.

The invention solves all of these problems through the use of hydrogen gas in a high concentration and at a comparatively high pressure (higher vacuum pressure) in the entire vacuum chamber or in large areas of the vacuum chamber for plasma generation. The special characteristics of hydrogen make it possible to efficiently suppress the emission of fast ions from the plasma while nevertheless ensuring a high transmission for EUV radiation.

Further, hydrogen has a cleansing effect in plasma radiation sources, particularly for optical components, without attacking their surfaces through sputtering.

There is only a very weak emission of radiation of unwanted wavelength ranges in the hydrogen plasma that is generated indirectly by the main plasma (emitter plasma). Further, the low electrical resistance of the hydrogen plasma can bring about a marked improvement in the discharge characteristics of discharge-based EUV radiation sources.

The solution according to the invention makes it possible to realize plasma-based radiation sources emitting short-wavelength radiation which have a long lifetime and in which extensive debris mitigation is achieved without severe impairment of the principal process of plasma generation due to the buffer gas (hydrogen) that is used and without requiring considerable extra expenditure for generating spatially narrowly limited partial pressure.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a schematic diagram of a discharge plasma-based radiation source with hydrogen as buffer gas inside the entire vacuum chamber for plasma generation and radiation focusing;

FIG. 2 shows a schematic diagram of a laser plasma-based radiation source with an additional device for the spatially limited increase in the partial pressure of the buffer gas (gas curtain);

FIG. 3 shows a graph showing the average range of Xe⁺ ions with a kinetic energy of 10 keV as a function of the transmission of different buffer gases at a wavelength of 13.5 nm and with a radiation path of 1500 mm;

FIG. 4 shows a graph showing the transmission of different buffer gases at a wavelength of 13.5 nm and with a radiation path of 1500 mm as a function of pressure;

FIG. 5 shows a schematic diagram of a laser plasma-based radiation source with an additional device for the spatially limited increase in the partial pressure of the buffer gas using a lamella filter arrangement;

FIG. 6 shows a schematic diagram of a discharge plasma-based radiation source with hydrogen as buffer gas inside the entire vacuum chamber for plasma generation and radiation focusing, wherein the current transfer between electrodes and the supply of emitter material in a locally limited manner is ensured by means of a hydrogen plasma.

### DETAILED DESCRIPTION OF THE PREFERRED EMBODIMENTS

The method according to the invention for operating a plasma-based short-wavelength radiation source with a high lifetime has the following steps:

an emitter material with a high emission efficiency in the desired wavelength range is supplied in a metered manner in a vacuum chamber for generating an emitter plasma;

hydrogen gas is introduced as buffer gas with a pressure-distance product in the range of 1 to 100 Pa·m;

a spatially narrowly limited hot emitter plasma is generated by a directed energy feed;

fast particles of emitter material are slowed down below a defined energy level (so-called sputter threshold) by impacts in the buffer gas;

the short-wavelength radiation exiting divergently from the emitter plasma is bundled by means of a collector in an intermediate focus;

the vacuum chamber is continuously suctioned out for quasistatic adjustment of pressure in the vacuum chamber and for removing excess emitter material and buffer gas.

At first glance, the use of hydrogen as buffer gas in an EUV radiation source seems unsuitable in view of its low atomic mass and the consequent poor braking effect on fast, comparatively heavy particles of emitter material (or electrode material). However, hydrogen has the following outstanding properties which make it attractive for this application:

The absorption cross section of H₂ for EUV radiation is the lowest of all gases. Its absorption is even so low that the ratio of collision cross section to absorption cross section has the absolute highest value of all available buffer gases (see FIG. 3) despite its poor braking effect on fast Xe particles. Therefore, hydrogen can be used within the radiation source at a much higher pressure and with much longer radiation path lengths (i.e., in expanded volumes) because this hardly impairs (absorbs) the generated EUV radiation, but increases the braking effect disproportionately.

The absorption cross section of fully ionized hydrogen is much lower for EUV radiation than that of the neutral H₂ molecule. The braking effect on fast particles is not negatively affected by the ionization.

In addition, hydrogen can be completely ionized with the lowest expenditure of energy of any element. Complete ionization is achieved automatically through the energy released by the emitter plasma.

Completely ionized hydrogen (like all completely ionized plasmas) only emits very little radiation. Consequently, an unnecessarily large amount of energy is not taken away from the emitter plasma to maintain the complete ionization of the hydrogen plasma.

Hydrogen has the lowest sputter rate of any element (see Table 2) for all of the materials used in functionally important components of an EUV radiation source.

Further, completely ionized hydrogen does not attack construction materials commonly used for an EUV source.

In addition, hydrogen plasma can also remove contaminants inside the vacuum chamber (e.g., from optical surfaces). Since all nonmetals in particular (with the exception of inert gases) can form volatile binary hydrogen compounds, nonmetallic contaminants are bonded inside the vacuum chamber and the volatile hydrogen compounds formed in this way are removed by suction through the vacuum system. Even metallic tin can be removed in this way in the form of volatile SnH₄.

Further, a comparison of completely ionized plasmas with electron density and temperature remaining the same shows that hydrogen plasmas have the lowest resistivity of all. This is very significant for discharge plasma-based radiation sources because the ohmic losses caused by the buffer gas are reduced.

In order to achieve average ranges for fast particles (10 keV) comparable to Ar or N₂ when using hydrogen as buffer gas, the pressure of H₂ gas must be selected approximately one order of magnitude higher all other conditions remaining the same (see Table 1) because the braking effect is proportional to the product of pressure and distance.

TABLE 1
Average ranges of Xe ions, Li ions, and Sn ions with an initial kinetic
energy of 10 keV in different gases at a pressure of 100 Pa.

| | average range | | |
|---|---|---|---|
| | [mm] of 10 keV ions | | |
| Gas at 1 mbar pressure | Xe⁺ | Li⁺ | Sn⁺ |
| H₂ | 135 | 605 | 139 |
| He | 113 | 847 | 114 |
| Ne | 29 | 223 | 29 |
| N₂ | 19 | 126 | 20 |
| Ar | 18 | 121 | 18 |
| Kr | 11 | 72 | 11 |
| Xe | 8 | 48 | 8 |

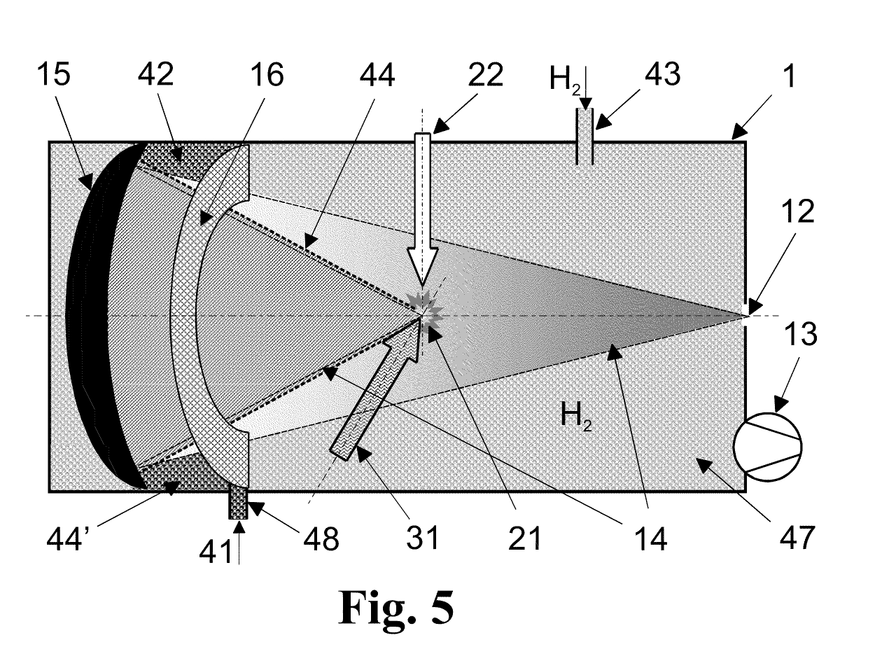

However, even with a radiation path length of 1500 mm, the transmission of EUV radiation is still sufficiently high (see FIG. 4) so that it is not absolutely necessary to produce steep pressure gradients in limited volumes within the beam guidance system.

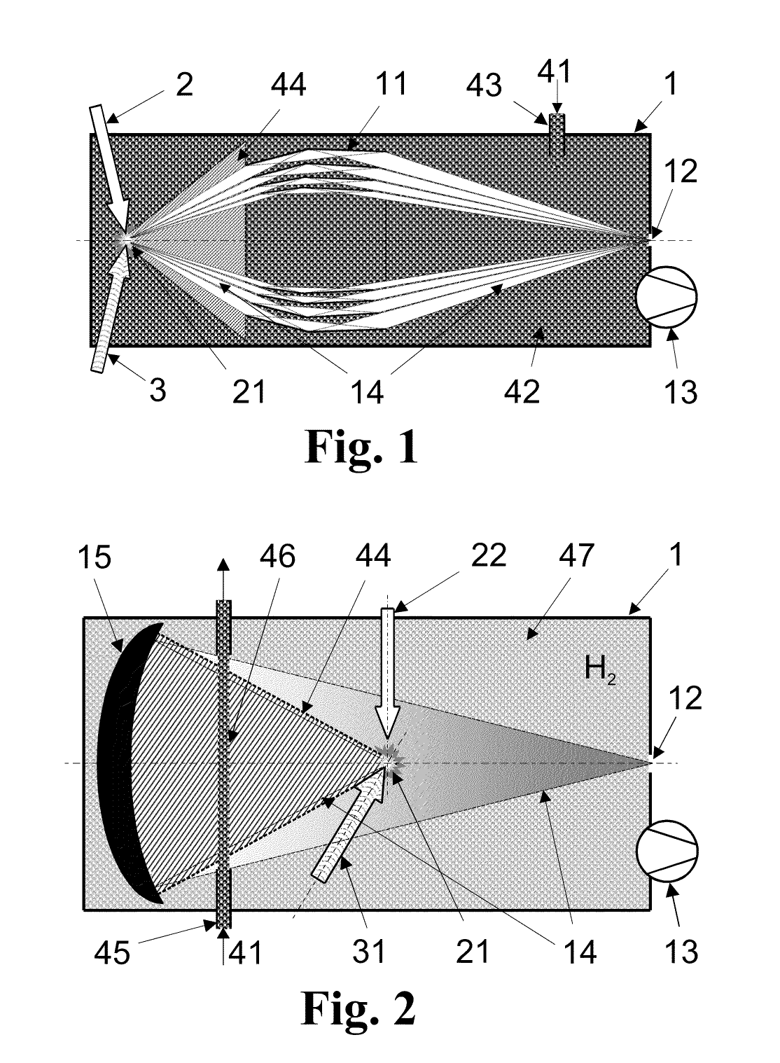

Therefore, complex structures such as lamella filters in the vicinity of the emitter plasma can be entirely dispensed with provided sufficient collision paths can be realized between the emitter plasma and the important optical components inside the EUV source. An arrangement of this kind is shown in FIG. 1.

The arrangement according to FIG. 1 shows a basic construction of a plasma-based short-wavelength radiation source. An emitter material feed 2 is provided in a vacuum chamber 1, and an emitter material, preferably liquid tin, a tin compound (e.g., SnClₓ), lithium, or liquefied xenon is converted into a hot emitter plasma 21 emitting EUV radiation at a defined location on the emitter material feed 2 by means of a pulsed energy feed 3. The emitter plasma 21 is projected by a collector 11 with grazing reflection (preferably a nested Wolter-type collector) in an intermediate focus 12 representing the output of the radiation source. A vacuum system 13 is provided for keeping the vacuum chamber under a desired pressure.

A debris filter 4 (which cannot be shown in its entirety) comprises a gas inlet 43, arranged at any location, for the buffer gas 41 which, according to the invention, is hydrogen which is held at a relatively high pressure in the entire vacuum chamber 1. The pressure is measured depending on the available collision volume 44 (strictly speaking, the collision path) from the emitter plasma 21 to the first functionally important optical element (collector 11) of the radiation source in which a pressure-distance product between 1 and 100 Pa·m is adjusted in order to reliably decelerate fast debris particles (≧10 keV) until they lose their sputtering capability, particularly for optical surfaces.

In order to achieve average ranges for fast particles (10 keV) comparable to Ar or N₂ when using hydrogen as buffer gas, the pressure of H₂ gas must be selected approximately one order of magnitude higher all other conditions remaining the same (see Table 1) because the braking effect is proportional to the product of pressure and distance. Assuming a distance between the emitter plasma and the collector 11 in the range of 100-500 mm, pressures greater than 100 Pa are necessary in practice for H₂ to achieve values of p·d>10 Pa·m, where p corresponds to the increased hydrogen pressure 42 which is adjusted in the entire vacuum chamber 1, and d is the distance from the emitter plasma 21 to the leading edge of the collector 11.

However, as has already been described, a high hydrogen pressure 42 of the kind mentioned above does not pose a problem, even inside the entire vacuum chamber 1, for the transparency of the generated EUV radiation. It may only make it necessary for the generation of a stable emitter plasma 21 to keep the plasma area under a lower pressure, i.e., to evacuate it separately.

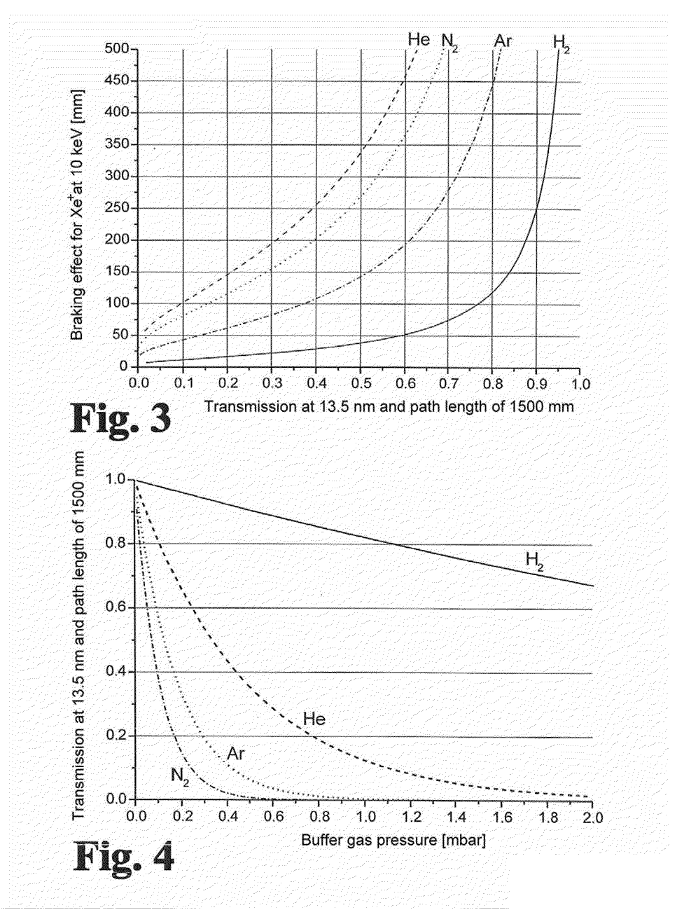

In special cases, this may involve generating a pressure gradient inside the radiation path 14 (e.g., to achieve very high braking effects within a very confined space). This is achieved by means of the usual methods using directed gas flows (according to FIG. 2) or lamella filters (according to FIG. 5).

FIG. 2 and FIG. 5 show a construction of the EUV source differing from that shown in FIG. 1 using a multilayer mirror 15 (collector with perpendicular reflection) to collect the radiation emitted by the emitter plasma 21 and transmit it into the intermediate focus 12.

In these two constructional variants, a directed emitter material feed 22 is provided which can be a continuous or discontinuous liquid or freezing target jet. An energy beam which—without limiting generality—is shown as a laser beam 31 but which can also be a particle beam (e.g., an electron beam) is directed onto this target jet.

In FIG. 2, the debris filter unit 4 is set up in such a way that a lower hydrogen pressure 47 (e.g., 10 . . . 50 Pa) is adjusted in the entire vacuum chamber 1 and determines the braking effect in the collision volume 44. In addition, there is a buffer gas curtain 46 between the emitter plasma 21 and the multilayer mirror 15 in which a buffer gas 41 is supplied via a supersonic nozzle 43 with oppositely arranged exhaust and is directed at a high pressure and a high flow rate within a very small space (in a narrow gas layer) through the vacuum chamber 1. The buffer gas 41 can be one of the known “heavy” buffer gases. However, the total expenditure on buffer gas extraction can be simplified also using hydrogen because the total volume of the vacuum chamber 1 can then be sucked out with the existing vacuum system 13 (without any transmission-reducing layering of another buffer gas) and can be adjusted to the lower hydrogen pressure 47.

In a basic construction very similar to that shown in FIG. 2, the debris filter unit 4 shown in FIG. 5 functions differently in that a lamella filter 16 is arranged between the emitter plasma 21 and the multilayer mirror 15. A buffer gas 41 is introduced additionally into this lamella filter 16 from the outside in approximately radial direction via a lamella filter gas feed 48. The lamella filter 16 preferably has two layers, the high partial pressure being adjusted in the intermediate space (not shown) and flowing off into the vacuum chamber 1 through the two lamella structures (as flow resistance). Owing to the narrower structure on the concave side of the lamella filter 16, the flowing off of buffer gas 41 will be greater and leads to a higher gas pressure 42 in the space toward the multilayer mirror 15 than on the plasma side in the hydrogen via the gas inlet 43, and the vacuum system 13 is held at a lower hydrogen pressure 47. In this case, the debris filter unit 4 has an appreciably reduced braking effect in the collision volume 44 on the plasma side, but a clearly higher impact rate in portion 44′ on the collector side in the space with higher buffer gas pressure 42. But in addition to this, the pressure level inside the lamella filter 16 is even greater, and its lamella structure also adds an adhesive filtering effect. In this way, the greatest overall filtering effect can be achieved within a very small space, although the distance between the emitter plasma 21 and the multilayer mirror 15 is exaggerated (in the interest of clarity) in the schematic diagram in FIG. 5.

This design variant is advantageous and is simplified when the buffer gas 41 introduced into the lamella filter 16 is also hydrogen. In this case, complicated separate evacuation steps on both sides of the lamella filter 16 can be dispensed with and—with a suitable dimensioning of the leakage rates of the lamella filter 16 —the gas inlet 43 can also be omitted.

Whereas for all of the other buffer gases, which are used only in the form of thin gas layers or gas curtains because of their high extinction of the radiation emitted from the emitter plasma 21, it is indispensable that the introduced gas load be evacuated as close as possible to the buffer gas flow, hydrogen buffer gas can be sucked out at any location due to the extremely low absorption.

Owing to its low ionization energy, hydrogen is completely ionized in the vicinity of the emitter plasma 21 of an EUV radiation source. The higher the output of the EUV radiation source, the larger the volume around the emitter plasma 21 in which the hydrogen is completely ionized. As a result of the complete ionization, the absorption cross section for EUV radiation is reduced on the one hand, and the completely ionized hydrogen can emit radiation only slightly on the other hand (only continuum radiation below the Lyman limit of 91.15 nm). Therefore, the hydrogen plasma loses only a little energy due to radiation emission and accordingly also does not generate any radiation disrupting the EUV process (so-called out-of-band radiation).

Compared to distinctly heavier elements, hydrogen has a very low sputter rate (see Table 2). Accordingly, only a negligible amount of secondary sputtering (sputtering through buffer gas particles) occurs on all of the materials used in functionally important components of an EUV radiation source. At the same time, such materials are not attacked by hydrogen (neither in atomic nor in ionized form).

TABLE 2
Sputter rates of molybdenum upon impact with different types of ions
at a kinetic energy of 10 keV.

| | Ion types each with a | | | |
|---|---|---|---|---|
| | kinetic energy of 10 keV | | | |
| | Xe⁺ | Ar⁺ | N⁺ | H⁺ |
| Sputter rate of molybdenum [atoms/ion] | 3.61 | 3.54 | 0.97 | 0.003 |

However, atomic or ionized hydrogen forms volatile binary compounds such as CH₄, NH₃, H₂O or HF with all nonmetals. Therefore, contamination (e.g., on optics) comprising compounds of nonmetals can be transformed into volatile hydrogen compounds and ultimately be removed through permanent evacuation via the vacuum system. This concerns primarily all contamination comprising carbon, nonvolatile hydrocarbons, tin coatings (insofar as Sn is used as an emitter element in EUV sources), and oxide layers.

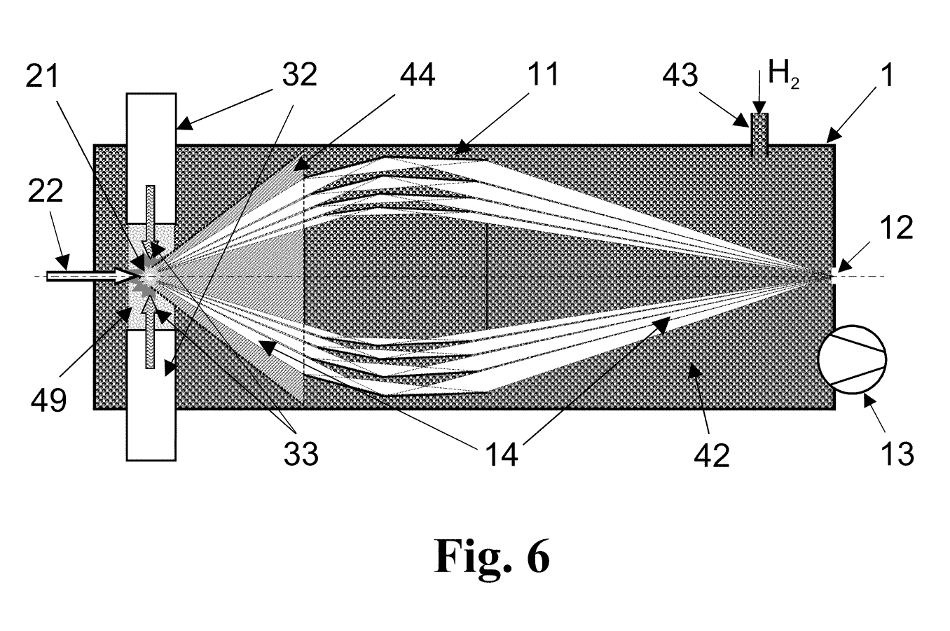

FIG. 6 shows an advantageous construction for discharge plasma-based (GDP) radiation sources which makes use of the advantages of hydrogen in the immediate vicinity of the emitter plasma 21. The low electrical resistance of completely ionized (current-carrying) hydrogen plasma 49 is used for this purpose. Accordingly, the electrical energy that is introduced into gaseous emitter material through the directed emitter material feed 22 by means of two electrodes 32 in this example is transmitted to the emitter material with low losses by the hydrogen plasma 49. In this case, the above-mentioned low energy losses of a hydrogen plasma 49 manifest themselves in a positive manner through self-radiation.

By means of the hydrogen plasma 49, the distance of the metal electrodes 32 from the emitter plasma 21 can be increased due to the good conductivity of the hydrogen plasma 49 because the hydrogen plasma 49 acts as a gaseous electrode extension 33 between the electrodes 32. An advantageous spatial separation between the hydrogen plasma 49 and emitter plasma 21 (shown only schematically in FIG. 6) can be achieved by gas-dynamic measures (e.g., gas jets in the electrodes 32). The rest of the elements are all arranged in a manner analogous to FIG. 1 so that a high hydrogen pressure 42 is employed in the entire vacuum chamber 1. The measure of buffer gas pressure is virtually unchanged due to the available path length in the collision volume 44 up to the collector 11.

The inventive use of hydrogen as buffer gas 41 inside the entire vacuum chamber 1 under a relatively high vacuum pressure makes it possible to devise other possibilities for generating the emitter plasma 21 without departing from the framework of the present invention. The type of emitter material, the preparation and excitation thereof for plasma generation, the type of beam bundling and the spatial ratios arising therefrom for any additional debris filtering measures can be modified in an optional manner. This does not affect the teaching of the use of the high transparency of the hydrogen buffer gas for purposes of creating spatially expanded, easily manageable collision volumes under high pressure in which complicated mechanical and/or fluidic filter steps are dispensed with or extensively simplified.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for operating plasma-based short-wavelength radiation sources, particularly EUV radiation sources, having the following steps:
generating an emitter plasma inside a vacuum chamber by using in a metered manner an emitter material with a high emission efficiency in a desired wavelength range;
introducing a hydrogen gas as a buffer gas into the vacuum chamber under a pressure such that a pressure-distance product is in the range of 1 to 100 Pa·m;
adjusting the pressure-distance product while taking into account the geometric radiation paths of the radiation emitted by the emitter plasma within the buffer gas;
generating a spatially narrowly limited hot emitter plasma by a directed energy feed;
slowing down fast particles of the emitter material by impacts with the hydrogen buffer gas particles in a collision volume;
bundling the short-wavelength radiation exiting divergently from the emitter plasma by means of collector optics;
continuously suctioning off the vacuum chamber to adjust quasistatic pressure in the vacuum chamber and to remove residual emitter material and excess buffer gas.

2. The method according to claim 1, further comprising providing the emitter material as a target jet in the vacuum chamber and exciting the emitter material by an energy beam at a predetermined interaction point to generate the emitter plasma.

3. The method according to claim 2, wherein providing the target jet comprises providing the target as a continuous liquid jet and exciting it by means of a laser beam.

4. The method according to claim 2, wherein providing the target jet comprises providing it as a discontinuous droplet jet and exciting it by means of a laser beam.

5. The method according to claim 1, wherein providing the emitter material comprises providing it a gas flow between two electrodes provided in the vacuum chamber and exciting the emitter material by an electric discharge between the electrodes to generate the emitter plasma.

6. The method according to claim 1, further comprising keeping the hydrogen gas as buffer gas under a pressure quasistatically in the entire vacuum chamber such that the pressure-distance product is in the range of 1 to 100 Pa·m depending on a geometric radiation path from the emitter plasma to the collector optics, thereby slowing down fast debris particles along said geometric radiation path through the vacuum chamber to a thermal energy below their capacity to sputter.

7. The method according to claim 1, further comprising keeping the hydrogen gas, as buffer gas under a pressure quasistatically in the entire vacuum chamber such that the pressure-distance product is in the range of 1 to 100 Pa·m while taking into account the geometric radiation paths of the radiation emitted by the emitter plasma, and additionally streaming in the buffer gas by supersonic nozzles in the form of a gas curtain arranged laterally to the radiation direction.

8. The method according to claim 1, further comprising keeping the hydrogen gas, as buffer gas under a pressure quasistatically in the entire vacuum chamber such that the pressure-distance product is in the range of 1 to 100 Pa·m while taking into account the geometric radiation paths of the radiation emitted by the emitter plasma, and hydrogen, and additionally streaming the buffer gas in by supersonic nozzles in the form of a gas curtain arranged laterally to the radiation direction.

9. The method according to claim 1, further comprising keeping the hydrogen gas as buffer gas under a pressure quasistatically in the entire vacuum chamber such that the pressure-distance product is in the range of 1 to 100 Pa·m while taking into account the geometric radiation paths of the radiation emitted by the emitter plasma, and additionally streaming the buffer gas in inside a lamella structure.

10. The method according to claim 1, further comprising keeping the hydrogen gas as buffer gas under the pressure quasistatically in the entire vacuum chamber such that a pressure-distance product is in the range of 1 to 100 Pa·m while taking into account the geometric radiation paths of the radiation emitted by the emitter plasma, and hydrogen, additionally streaming the buffer gas in inside a lamella structure.

11. An arrangement for generating plasma-based short-wavelength radiation comprising:
means for supplying an emitter material having a high emission efficiency in an extreme ultraviolet spectral range;
means for exciting the emitter material to form a spatially narrowly limited hot emitter plasma; and
provided in a vacuum chamber means for suppressing debris particles generated from the emitter plasma, wherein
a feed device for introducing hydrogen gas as a buffer gas into the vacuum chamber is provided as the means for suppressing the debris particles;
means for regulating pressure connected to the vacuum chamber; and
the hydrogen gas is adjusted quasistatically by the means for regulating pressure to a pressure such that a pressure-distance product is in the range of 1 to 100 Pa·m while taking into account geometric radiation paths of the radiation emitted by the emitter plasma up to the collector.

12. The arrangement according to claim 11, wherein the feed device for the hydrogen gas is arranged at any location in the vacuum chamber and is adjusted in such a way that the hydrogen serving as buffer gas has a quasistatic pressure in the entire vacuum chamber such that a pressure-distance product falls in the range of 1 to 100 Pa·m depending on the geometric radiation path within a collision volume from the emitter plasma up to the collector optics so that fast debris particles are slowed down along said geometric radiation path through the vacuum chamber to a thermal energy below their capacity for sputtering.

13. The arrangement according to claim 11, wherein the feed device for the hydrogen gas is arranged in such a way that the hydrogen is supplied in the immediate vicinity of the emitter plasma at increased partial pressure relative to the pressure in the rest of the vacuum chamber, and wherein a vacuum system of the vacuum chamber is provided at the same time for sucking out the buffer gas and adjusting a lower quasistatic hydrogen pressure in the rest of the vacuum chamber.

14. The arrangement according to claim 11, wherein the feed device for the hydrogen gas is arranged in such a way that the hydrogen is supplied in the immediate vicinity of the emitter plasma at an increased partial pressure relative to the pressure of the vacuum chamber in the area of the emitter plasma, and wherein at least one separate gas sink for locally limiting a volume with increased partial pressure is located in the vicinity of the emitter plasma.

15. The arrangement according to claim 12, further comprising means for introducing the hydrogen gas into the entire vacuum chamber, and means for introducing the buffer gas at an increased partial pressure for generating a buffer gas layer oriented substantially laterally to a mean propagation direction of the emitted radiation in the immediate vicinity of the emitter plasma.

16. The arrangement according to claim 15, further comprising in the immediate vicinity of the emitter plasma means for introducing the buffer gas at the increased partial pressure for generating a gas curtain laterally to the mean propagation direction of the emitted radiation.

17. The arrangement according to claim 15, further comprising in a lamella filter means for introducing the buffer gas at the increased partial pressure, wherein a virtually lateral buffer gas layer is formed inside the lamella filter due to a flow resistance.

18. The arrangement according to claim 15, further comprising means for introducing the buffer gas at the increased partial pressure are likewise provided for introducing hydrogen.
